(19) United States
(12) Patent Application Publication
(10) Pub. No.: US 2013/0333673 A1
(43) Pub. Date: Dec. 19, 2013

(54) HEATING OF FUEL WITH EXHAUST GAS RECIRCULATION

(71) Applicant: Transonic Combustion, Inc., Camarillo, CA (US)

(72) Inventors: Michael Frick, Newbury Park, CA (US); Wolfgang Bullmer, Camarillo, CA (US); Philip Silvester Zoldak, Phoenix, AZ (US); Morse Nathan Taxon, Erie, PA (US)

(73) Assignee: Transonic Combustion, Inc., Camarillo, CA (US)

(21) Appl. No.: 13/896,116

(22) Filed: May 16, 2013

Related U.S. Application Data
(60) Provisional application No. 61/647,687, filed on May 16, 2012.
(60) Provisional application No. 61/778,911, filed on Mar. 13, 2013.

(51) Int. Cl. F02M 31/04

(52) U.S. Cl. CPC F02M 31/04
USPC 123/557

(57) ABSTRACT

Methods and systems for efficiently utilizing a fuel heating system incorporating an exhaust gas recirculation (“EGR”) stream and an EGR cooling system are disclosed. Waste heat energy in an exhaust gas recirculation stream of an engine system is used to heat the fuel being fed to the combustion chambers of the engine. A conventional EGR cooler can be replaced with a fuel heat exchanger/EGR cooler. Utilizing these components allows fuel heating to be accomplished simultaneously with partial EGR gas cooling by using waste EGR heat. This reduces the heat rejection requirement of the engine coolant and also reduces the electrical power requirements of the fuel heater.

### CROSS REFERENCE TO RELATED APPLICATIONS

This application claims the benefit of U.S. Provisional Application Ser. No. 61/647,687 to Michael Frick et al., entitled Heating of Fuel with Exhaust Gas Recirculation, filed on May 16, 2012. This application also claims the benefit of U.S. Provisional Application Ser. No. 61/778,911, to Michael Frick et al., also entitled Heating of Fuel with Exhaust Gas Recirculation, filed on Mar. 13, 2013. Both of these provisional applications are hereby incorporated herein in their entirety by reference, including the drawings, charts, schematics, diagrams and related written description.

### BACKGROUND OF THE INVENTION

1. Field of the Invention

The present invention relates generally to internal combustion engines, for example, internal combustion engines incorporating heated fuel temperature controls and exhaust gas recirculation components.

2. Description of the Related Art

Modern internal combustion engines are ubiquitous and utilized in many different applications, including most modern automobiles and in industrial manufacturing machinery. Internal combustion engines function by combusting a fuel (which can be several fuel types including a hydrocarbon based fuel or a biodiesel fuel and can be mixed with various additives such as ethanol) in a combustion chamber with an oxidative agent (typically ambient air) within a fluid-flow circuit (such as a fuel rail system). During the combustion process, the expansion of the high-temperature and high-pressure gases apply force to some component of the engine (typically pistons or turbine blades). The applied force moves the component over a distance, transforming chemical energy into mechanical energy.

In some engine systems, a source of heat is required for the proper or optimal function of one or more engine components or to heat the fuel itself. For example, many engine systems developed by the assignee of the present application, Transonic Combustion, Inc., utilize a heating source to elevate the temperature of the fuel to or toward supercritical conditions, which is beneficial for several reasons. These engine systems utilizing fuel in supercritical conditions often also utilize a cooled exhaust gas recirculation (“EGR”) system as a method of controlling combustion and subsequent emissions

Fuel heating and EGR cooling components in an engine system, such as described above, in various embodiments are interfaced with two separate and independent systems. The EGR is typically cooled by heat exchange with an engine coolant, which increases the heat of the coolant and necessitates greater radiator and coolant capacity in the engine system. The fuel heater is typically heated electrically, with electrical energy being provided by the alternator. This extracts energy that would otherwise be utilized to power the engine, reducing overall fuel efficiency. Additionally, the wire diameter and necessary electronics required to utilize and control such a fuel heating system add significant mass to the vehicle.

An efficient method and system for utilizing a fuel heating system together with an EGR cooling system is therefore needed.

### SUMMARY OF THE INVENTION

Described herein are methods and systems for efficiently utilizing a fuel heating system together with an EGR cooling system. Embodiments incorporating features of the present invention utilize the available waste heat energy in the exhaust gas recirculation stream of an engine to heat the fuel. In certain embodiments, fuel is heated in this manner to supercritical or near supercritical levels, for example, by utilizing waste heat from the exhaust gas upstream of an EGR component, such as an EGR cooler, to heat the fuel to a desired temperature. In some embodiments this is accomplished by replacing a conventional EGR cooler with a fuel heat exchanger/EGR cooler. Many different arrangements are possible in designing fuel heat exchanger/EGR coolers such as shown by various alternative embodiments herein below.

The present disclosure describes various methods and systems which have several different advantages, some of which are as follows. One advantage of methods and systems according to the present disclosure is that fuel can be heated using heat from the exhaust gas upstream of the EGR cooler which would otherwise be wasted by heat transfer in the cooling stage of the EGR loop. Another advantage of the heat transfer from the exhaust gas to the fuel is that less heat remains in the exhaust gas that subsequently must be cooled by an EGR heat exchanger to reduce the heat remaining in the exhaust gas to acceptable levels for EGR. Yet another advantage is that by using exhaust gas to heat the fuel, the power requirement for various additional components, such as an electric fuel heater, is reduced and could potentially be negligible. This can result in a smaller electric heater being sufficient, thus providing power/performance savings, reduced overall vehicular weight and a longer service life.

Additional advantages of methods and systems disclosed herein include eliminating loss of enthalpy to the turbocharger, increasing packaging efficiency as the EGR loop is typically in an easier to access location, and allowing the fuel heat exchanger to not have to handle the volume of exhaust present at high-load conditions, thus reducing the chance for occurrence of overheating conditions.

In one embodiment disclosed herein, a method for heating fuel in an engine system comprises providing an engine system including a recirculating exhaust gas stream, placing a heat exchanger in the engine system such that the EGR stream passes through and provides waste heat to the heat exchanger, and flowing fuel through the heat exchanger so as to transfer the waste heat from the EGR stream to the fuel.

In another embodiment, a method for heating fuel in an engine system comprises providing an exhaust gas recirculating stream within an engine system, wherein the EGR stream flows through a heat exchanger, and the heat exchanger includes an EGR cooler, such that the exhaust gas recirculating stream provides waste heat to the heat exchanger followed by said EGR cooler, and then flowing fuel through said heat exchanger so as to transfer heat from the EGR stream to the fuel.

These and other further embodiments, features and advantages of the invention would be apparent to those skilled in the art based on the following detailed description, taken together with the accompanying drawings, in which:

### BRIEF DESCRIPTION OF THE DRAWINGS

FIG. 1A is a representation of an engine schematic incorporating features of the present invention;

FIG. 1B is an enlarged view of the EGR portion of the engine system shown in FIG. 1A;

FIG. 2 is a representation of a first embodiment of an EGR system incorporating features of the present invention;

FIG. 3 is a representation of a second embodiment of an EGR system incorporating features of the present invention;

FIG. 4 is a first graphical representation depicting initial engine test results for an embodiment incorporating features of the present invention, showing EGR 0% versus various emission standards;

FIG. 5 is a second graphical representation depicting initial engine test results for an embodiment incorporating features of the present invention, showing EGR 0% versus various emission standards; and

FIG. 6 is a graphical representation depicting a temperature prediction scheme based on engine boundary condition analysis with the engine operating at various load levels for an embodiment incorporating features of the present invention.

### DETAILED DESCRIPTION OF THE INVENTION

The present disclosure is directed to methods and systems efficiently utilizing a fuel heating system together with an EGR cooling system. Embodiments incorporating features of the present invention utilize the available waste heat energy in the exhaust gas recirculation stream of an engine system to heat the fuel.

Adding a fuel heat exchanger/EGR cooler to a conventional EGR cooler can provide many benefits to the engine system, including, but not limited to, utilizing this structure allows fuel heating to be accomplished simultaneously with partial EGR gas cooling using waste EGR heat. An exhaust fuel heater/EGR cooler can be placed in many locations within an engine system as described below, including but not limited to a high pressure EGR loop directly upstream of the turbocharger or in a low pressure loop downstream of the turbocharger. This reduces the heat rejection requirement of the engine coolant and also reduces the electrical power requirements of the fuel heater. In addition, by moving the exhaust and fuel heat exchange components out of the main exhaust stream, there is no loss in enthalpy to the turbocharger, packing becomes easier (as the EGR loop can be in an easier access location) and the fuel heat exchanger does not have to handle the volume of exhaust present at higher load conditions (this can prevent or mitigate the effects of overheating).

In some embodiments of methods and systems incorporating features of the present invention a bypass mechanism, such as a bypass valve can be used. This allows fuel to be bypassed away from the EGR cooler portion of a fuel heat exchanger/EGR cooler during situations wherein exposure to the EGR cooler would be less than ideal, for example, during cold starts. In some embodiments, the bypass mechanism can comprise a variable bypass valve (such as a 3-way valve) that can be proportionally controlled, for example by an ECU with a sensor feedback loop. This proportional control enables the amount of fuel bypassed to a heater portion to be more precisely controlled. It is thus understood that the bypass mechanism can be adjusted such that it is “completely open” or “partially open” in order to vary the amount of fuel that is routed to a different in-line direction.

In some embodiments, when the bypass valve is open, for example, during an engine cold start, the fuel inside the heat exchange portion is exposed to exhaust temperatures without a fuel mass flow rate which improves fuel heating during cold starts. Once an acceptable fuel temperature has been reached (which can be detected by various means, for example, by a sensor feedback loop with the ECU), the fuel bypass mechanism can be closed (i.e. completely closed or proportionally closed) to begin fuel flow through the fuel heat exchanger and any downstream electric fuel heater power can be reduced.

During times when the fuel bypass valve is closed and the fuel is flowing through the heat exchanger and EGR gas temperature is high, the fuel can become overheated. The bypass mechanism can then be adjusted to bypass the fuel away from the fuel heat exchanger to more closely maintain a target fuel temperature. One additional benefit to utilizing a fuel bypass mechanism is that it enables a rapid response to fuel heat exchanger failure. If the fuel heat exchanger fails internally, then the fuel will enter into the EGR cooler and subsequently into the intake manifold, causing the engine to lose control or become damaged. However, a pressure sensor can be utilized, for example, in a feedback loop with an ECU, to determine the presence of a leak and the fuel bypass valve can be adjusted to prevent an excessive amounts of fuel from being released into the EGR cooler.

Throughout this disclosure, the preferred embodiments herein and examples illustrated are provided as exemplars, rather than as limitations on the scope of the present disclosure. As used herein, the terms “invention,” “method,” “system,” “present method,” “present system” or “present invention” refers to any one of the embodiments incorporating features of the invention described herein, and any equivalents. Furthermore, reference to various feature(s) of the “invention,” “method,” “system,” “present method,” “present system,” or “present invention” throughout this document does not mean that all claimed embodiments or methods must include the referenced feature(s).

It is also understood that when an element or feature is referred to as being “on” or “adjacent” another element or feature, it can be directly on or adjacent the other element or feature or intervening elements or features that may also be present. Furthermore, relative terms such as “outer”, “above”, “lower”, “below”, and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” transducer, it is understood that this language encompasses a single transducer or a plurality or array of transducers. It will be further understood that the terms “comprises,” “comprising,” “includes” and/or “including when used herein, specify the presence of stated features, integers, steps, operations, elements, and/or components, but do not preclude the presence or addition of one or more other features, integers, steps, operations, elements, components, and/or groups thereof.

In reference to the present application the term, “in communication with” can refer to being in electrical communication with (e.g. a power supply and heater), able to transmit and/or receive information from (e.g. a sensor and an engine control unit (“ECU”)), or able to affect in a significant manner (e.g. a heater in communication with fuel in a given location is able to affect the temperature of that fuel).

In reference to the present application the term, “downstream” or “downstream from,” refers to the position of an object or a site for application of a method that receives the flow of fuel subsequent to another object. For example, if fuel passes through a rail system prior to entering an injector, the injector is said to be “downstream from” the rail system. Likewise, the term “upstream” or “upstream from” refers to the position of an object or a site for application of a method that receives the flow of fuel prior to another object.

Methods and systems disclosed herein can be utilized in any engine system that incorporates internal combustion features and are particularly suited for use in engines utilizing heated fuels. Examples of heated fuel injection systems, including their drawings, schematics, diagrams and related written description, are set forth in, for example, U.S. Pat. No. 8,176,900; U.S. Pat. No. 8,116,963; U.S. Pat. No. 8,079,348; U.S. Pat. No. 7,992,545; U.S. Pat. No. 7,966,990; U.S. Pat. No. 7,945,375; U.S. Pat. No. 7,762,236; U.S. Pat. No. 7,743,754; U.S. Pat. No. 7,657,363; U.S. Pat. No. 7,546,826; and U.S. Pat. No. 7,444,230, which are incorporated herein in their entirety by reference.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

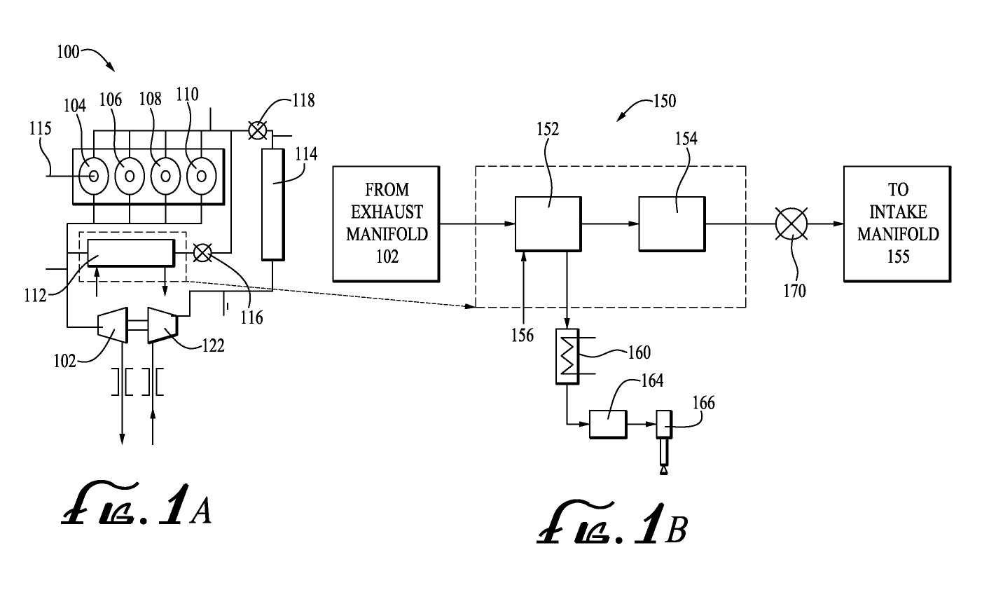

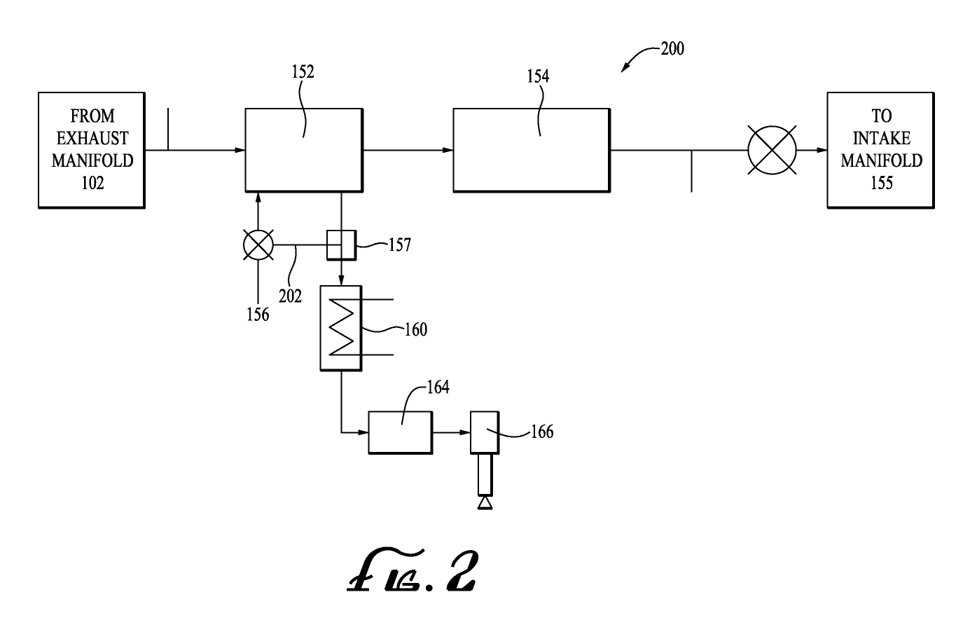

FIGS. 1A and 1B depict a representation of an engine schematic incorporating features of the present invention. FIG. 1A shows an engine system 100 that is an example environment in which embodiments incorporating features of the present invention can be implemented. The engine system 100 comprises an exhaust manifold or element such as a turbine 102, engine cylinders 104, 106, 108, 110, an EGR cooler 112 and an engine charge air cooler (“CAC”) 114. Fuel can enter the engine system 100 at a fuel intake point 115, from a fuel dispensing system such as a fuel injection system.

An engine system 100 can further comprise a first sensor 116 that can detect EGR pressure and EGR temperature and a second sensor 118 that can detect CAC pressure and CAC temperature. These sensors 116, 118 can be in communication with an ECU which can receive input from the sensors 116 (shown here placed in the location of an EGR valve), 118 (shown here placed near the throttle position), and can provide feedback control to individual engine components. Exhaust exits from the exhaust manifold 102, releasing exhaust in the form of smoke, Noₓ, CO and CO₂. Ambient air can enter into the engine system 100 through an intake element 122, which can be a compressor. Although a particular engine system 100 has been disclosed, it is understood that this engine system is simply an example environment for embodiments incorporating features of the present invention and that many different engine systems can be utilized with methods, devices and systems according to the present disclosure.

The EGR cooler 112 in an engine system 100 can be replaced with a fuel heat exchanger/EGR cooler system 150 best shown in the enlarged view of FIG. 1B. The fuel heat exchanger/EGR cooler 150 comprises a fuel heat exchanger portion 152 and a coolant EGR portion 154. Exhaust from the exhaust manifold 102 enters into the heat exchanger portion 152 where it can interact with and heat the fuel. The exhaust gas can then pass through the EGR cooler portion 154 and subsequently to the intake manifold 155.

The fuel 156 having a first temperature can enter the fuel heat exchanger portion 152 where it can interact with heated exhaust gas from an exhaust manifold 102. The fuel can exit the fuel heat exchanger portion having a second temperature 158 and can further interact with additional elements such as a fuel heater 160, which can further heat the fuel, causing fuel having a third temperature to enter into a rail system 164 and subsequently into a fuel injector 166. The fuel injector 166 can further comprise a heater portion that allows fuel within the fuel injector to be further heated and injected into the combustion chamber through an injector 168 at a fourth temperature.

It is understood that while the heat exchanger and EGR cooler are referred to as separate structures, they can also be integrated structures, for example having the heat exchanger portion 152 and the coolant EGR portion 154 as combined structures located in a single housing.

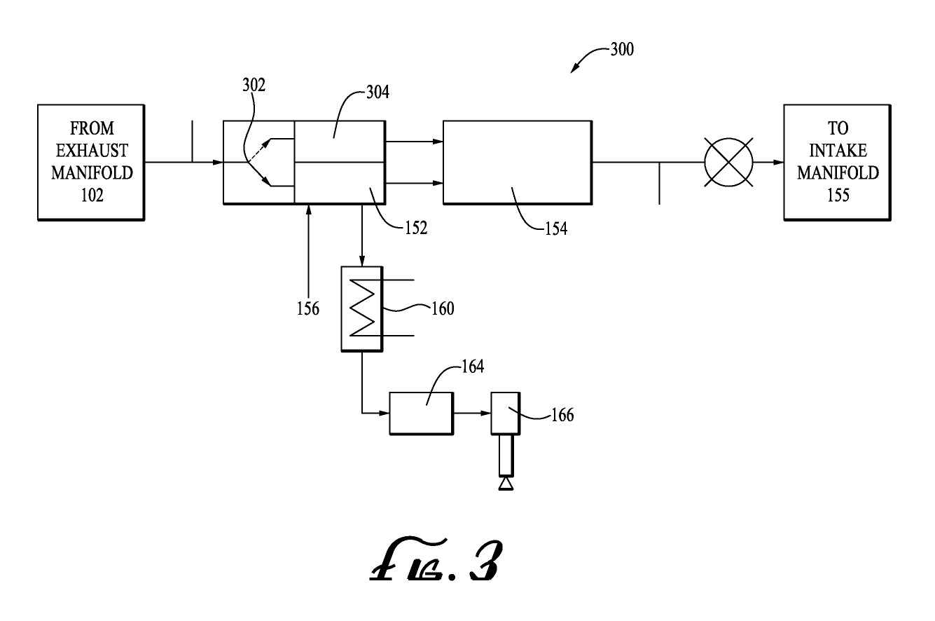

FIG. 2 depicts a fuel heat exchanger/EGR cooler 200, similar to the fuel heat exchanger/EGR cooler 150 in FIG. 1 above wherein the above embodiment is incorporated such that like reference numbers denote like features. The fuel heat exchanger/EGR cooler 200 of FIG. 2 further comprises a heat exchanger bypass mechanism 202, which can be a fuel bypass valve. Fuel enters into the heat exchanger/EGR cooler 200 at a location 156. Under certain conditions, where a greater initial fuel temperature is desired, for example, during cold start, the bypass valve can bypass fuel away from the cooler fuel heat exchanger 152 directly to the electric fuel heater 160 for more rapid fuel temperature increase. During this time, fuel trapped inside the heat exchanger 152 will not be flowing and will be exposed to the higher temperatures for longer periods of time, thus allowing the trapped fuel to be warmed rapidly during a cold start. An additional advantage of this fuel bypass mechanism 202 is that it allows rapid response to an emergency failure condition by bypassing fuel away from an excessively hot EGR cooler and preventing excessive fuel heating by EGR gas.

Referring again to the fuel heat exchanger/EGR cooler 200 shown in FIG. 2, an example control system 157 is disclosed. Using this system, feedback control is provided on the second fuel temperature feed 158 versus a desired setpoint, for example, a supercritical fuel temperature setpoint. This control system utilizes an ECU that receives temperature inputs and the exhaust gas input, fuel inlet temperature, and the intermediate temperature of the fuel within the fuel heat exchanger portion 152. These inputs are used to determine the amount of electric heater power needed to achieve the target fuel temperature at the second fuel temperature 158 point. This control system can be used in combination with the bypass valve to also control the relative amount of heating.

In embodiments of the present invention utilizing fuel under supercritical conditions, supercritical temperatures can still be primarily controlled by the electric heater 160 and the final heat of the fuel immediately prior to injection can still be controlled by a heater within or in communication with the fuel injector body 166 itself.

FIG. 3 depicts a fuel heat exchanger/EGR cooler 300, similar to the fuel heat exchanger/EGR cooler 150 shown in FIG. 1 wherein the above embodiment is incorporated such that like reference numbers denote like features. The fuel heat exchanger/EGR cooler 300 can also be utilized in an example environment such as the engine system 100 above. Exhaust from the exhaust manifold 102 enters into the fuel exchanger portion 152 where it can interact with and heat the fuel. The exhaust gas can then pass through the EGR cooler portion 154 and subsequently to the intake manifold 155. Also like the fuel heat exchanger/EGR cooler 150 of FIG. 1B above, the fuel heat exchanger/EGR cooler 300 of FIG. 3 further comprises an electric heater 160, a rail system 164, and a fuel injector 166. In another embodiment, only between about 20-40% of the exhaust gas in the EGR loop is utilized for heating the fuel. The 20-40% portion of the EGR flow passes through a bypass valve and into the fuel heat exchanger for heating the fuel. Upon exiting the fuel heat exchanger, this 20-40% flow rejoins the reminder of the exhaust gas flow either before or after the EGR cooler.

The fuel heat exchanger/EGR cooler 300 is arranged in a series flow with an EGR bypass mechanism. The EGR bypass mechanism comprises an EGR bypass valve 302 and a bypass tube 304. The arrangement of the fuel heat exchanger/EGR cooler 300 allows for the exhaust gas from the intake manifold 102 to directly bypass the fuel heat exchange portion 152 via bypass tube 304. This allows fuel to flow through the heat exchanger portion 152 directly but not be significantly heated during bypass. This embodiment is similar to the embodiment in FIG. 2 regarding the conditions under which bypass is desired, the advantages of bypass and the applicable control mechanisms.

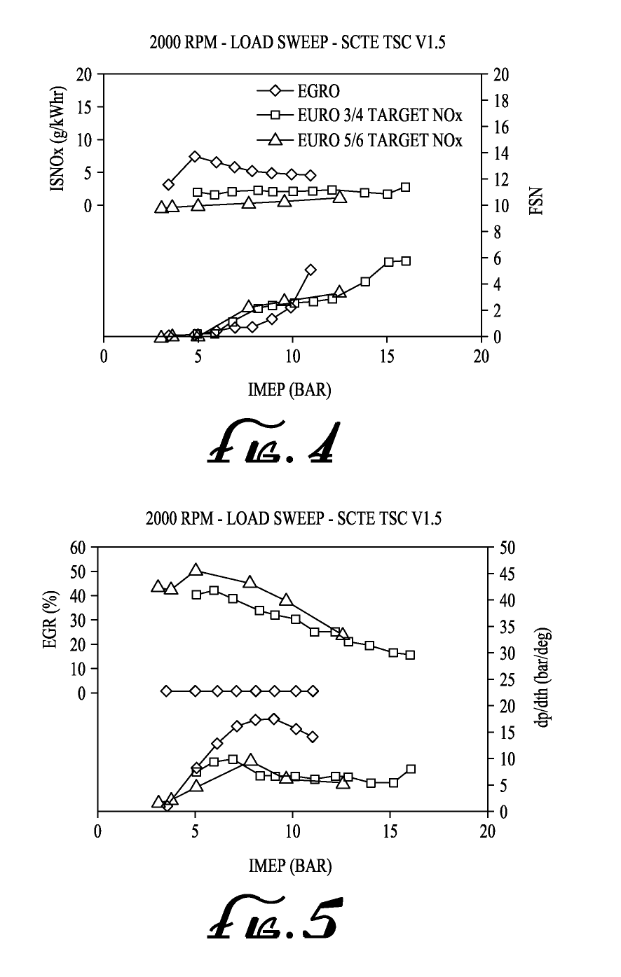

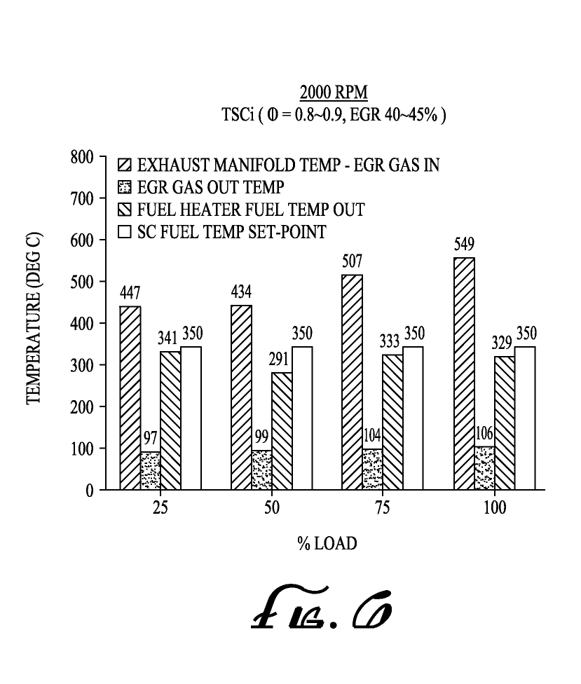

FIGS. 4 and 5 show examples of initial test results depicted as a graphical representations. FIG. 4 depicts EGR 0% versus Targeted EGR levels (i.e. Euro 3/4 NOₓ and Euro 5/6 NOₓ) for a 2000 rpm Load Sweep utilizing the EGR setup depicted in FIG. 1. FIG. 4 depicts two separate plots: 1) indicated mean effective pressure (“IMEP”) versus NOx emission; and IMEP versus filter smoke number (“FSN”). FIG. 5 also depicts two separate plots: 1) IMEP versus EGR (%); and IMEP versus change in pressure over change in temperature.

The above initial engine testing concluded that around 20-40% of the total exhaust gas stream is optimal for EGR to achieve NOₓ emission targets of 1.0 g/kWhr. These test results additionally demonstrated that EGR had the additional benefit of controlling in-cylinder pressure rise rates to less than 10 bar/deg across an engine load range. One advantage of this is that it helps reduce combustion noise associated with the combustion process. Testing was completed at 2000 rpm on a 390 cc single cylinder engine using gasoline fuel and a fuel injection system.

FIG. 6 depicts predicted temperatures of EGR gas in, EGR gas out and fuel temperatures after the fuel heater section utilizing the setup depicted in FIG. 1. To arrive at this data, a boundary condition analysis was completed for the fuel heater/EGR cooler design to establish predictable performance. This analysis utilized an empirical model of a light duty compression ignition turbocharged engine developed specifically for supercritical fuel combustion using high EGR amounts. The EGR gas flow rates and EGR gas in temperatures as well as fuel flow rates were determined based on inputs from a single cylinder testing and past experiences with multi-cylinder testing.

To obtain the results presented in FIG. 6, the fuel heater was assumed to have a capacity of 15% of total EGR cooler heat rejection capacity. The remaining 85% heat reaction of the EGR cooler is accomplished by the second stage with engine coolant. The graph depicted in FIG. 6 shows that the fuel heater section is capable of heating the fuel to the target temperatures (in this case, SC fuel temp set point 350° C.) for 2000 rpm at various loads (i.e. 25%, 50% and 100% loads). A small amount of electrical fuel heating (difference between SC fuel temp set point and fuel heater temp out) is still needed to reach the target temperature of 350° C. at low loads for the 1750 rpm speed.

1. A method for heating fuel in an engine system, comprising:
providing an engine system including a recirculating exhaust gas (“EGR”) stream;
placing a heat exchanger in the engine system such that said EGR stream passes through and provides waste heat to said heat exchanger; and
flowing fuel through said heat exchanger so as to transfer said waste heat from the EGR stream to the fuel.

2. The method of claim 1, wherein said engine system further comprises an EGR bypass mechanism.

3. The method of claim 2, wherein said bypass mechanism comprises a variable 3 way valve.

4. The method of claim 1, wherein said engine system further comprises an EGR cooler.

5. (canceled)

6. The method of claim 4, wherein said engine system further comprises an EGR bypass mechanism.

7. The method of claim 6, wherein said bypass mechanism comprises a variable 3 way valve.

8. The method of claim 6, wherein said bypass valve is configured to allow fuel to bypass said heat exchanger.

9. The method of claim 6, wherein said bypass valve allows exhaust gas to bypass said heat exchanger.

10. The method of claim 4, wherein said heat exchanger is arranged in series flow with said ERG cooler.

11. The method of claim 4, wherein said heat exchanger is arranged in parallel flow with said ERG cooler.

12-21. (canceled)
